(19) United States
(12) Patent Application Publication
(10) Pub. No.: US 2023/0247522 A1
(43) Pub. Date: Aug. 3, 2023

(54) SYSTEMS AND METHODS OF INITIAL ONBOARDING AND STEERING FOR WI-FI DEVICES

(71) Applicant: Meta Platforms Technologies, LLC, Menlo Park, CA (US)

(72) Inventors: Chunyu HU, Saratoga, CA (US); Connor KENNEDY, San Francisco, CA (US); Yixiang LI, Fremont, CA (US); Chittabrata GHOSH, Fremont, CA (US); Trilok Kumar MUTYALA, Sunnyvale, CA (US)

(21) Appl. No.: 18/099,648

(22) Filed: Jan. 20, 2023

Related U.S. Application Data
(60) Provisional application No. 63/304,357, filed on Jan. 28, 2022.

(51) Int. Cl. H04W 40/34; H04W 8/00

(52) U.S. Cl. CPC H04W 40/34; H04W 8/005; H04W 84/12

(57) ABSTRACT

A first device connected in a wireless local area network (WLAN) may include one or more processors. The one or more processors may be configured to associate with a first access point. The one or more processors may be configured to wirelessly receive, via a transceiver from a second device, a first frame. The one or more processors may be configured to wirelessly receive, via the first access point, a second frame. The one or more processors may be configured to compare an identifier indicated in the first frame with an identifier indicated in the second frame. The one or more processors may be configured to determine, based at least on a result of the comparing, whether the first device continues to associate with the first access point or associates with a software-enabled access point (soft-AP) configured in the second device.

### CROSS-REFERENCE TO RELATED APPLICATION

This application claims priority to U.S. Provisional Patent Application No. 63/304,357 filed on Jan. 28, 2022, which is incorporated by reference herein in its entirety for all purposes.

### FIELD OF DISCLOSURE

The present disclosure is generally related to communications, including but not limited systems and methods for a wireless device to switch from an access point (AP) to a software enabled access point (soft-AP) based on beacons received by the wireless device.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a first device connected in a wireless local area network (WLAN) and including one or more processors. In some embodiments, the one or more processors may be configured to associate with a first access point. The one or more processors may be configured to wirelessly receive, via a transceiver from a second device, a first frame. The one or more processors may be configured to wirelessly receive, via the first access point, a second frame. The one or more processors may be configured to compare an identifier indicated in the first frame with an identifier indicated in the second frame. The one or more processors may be configured to determine, based at least on a result of the comparing, whether the first device continues to associate with the first access point or associates with a software-enabled access point (soft-AP) configured in the second device.

In some embodiments, the first frame may be one of a beacon frame, a probe response frame, or a fast initial link setup (FILS) discovery frame. In some embodiments, the second frame may be a domain name system (DNS) frame or a multicast domain name system (mDNS) frame. In some embodiments, each of the identifier indicated in the first frame and the identifier indicated in the second frame may be a basic service set identifier (BSSID).

In some embodiments, the one or more processors may be further configured to determine whether a first field of the first frame is set to a first value indicating the soft-AP. In response to determining that the first field of the first frame is set to the first value, the one or more processors may be configured to disassociate from the first access point and associate with the soft-AP. The first field of the first frame may include one of a vendor specific information element (VSIE), a short service set identifier (SSSID), or an organizationally unique identifier (OUI). The one or more processors may be further configured to determine whether a second field of the first frame is set to a second value indicating that the second device includes multiple radios. In response to determining that: (1) the first field of the first frame is set to the first value and (2) the second field of the first frame is set to the second value, the one or more processors may be configured to disassociate from the first access point and associate with the soft-AP. In some embodiments, in response to determining that the first device associates with the soft-AP, the one or more processors may be configured to add the identifier indicated in the first frame to a soft-AP list.

In some embodiments, the one or more processors may be further configured to wirelessly receive, via the first access point, a third frame. The one or more processors may be configured to determine whether an identifier indicated in the third frame is present in the soft-AP list. In response to determining that the identifier indicated in the third frame is present in the soft-AP list, the one or more processors may be configured to disassociate from the first access point and associate with the soft-AP. In response to determining that the identifier indicated in the third frame is not present in the soft-AP list, the one or more processors may be further configured to wirelessly receive, from the second device, a fourth frame, and determine whether a field of the fourth frame is set to a particular value indicating the soft-AP. In response to determining that the field of the fourth frame is set to the particular value, the one or more processors may be configured to compare an identifier indicated in the fourth frame with an identifier indicated in the third frame. In response to determining that the identifier indicated in the fourth fame matches the identifier indicated in the third frame, the one or more processors may be configured to add the identifier indicated in the third frame to the soft-AP list.

Various embodiments disclosed herein are related to a method including associating, by a first device connected in a wireless local area network (WLAN), with a first access point. The method may include wirelessly receiving, by the first device via a transceiver from a second device, a first frame. The method may include wirelessly receiving, by the first device via the first access point, a second frame. The method may include comparing, by the first device, an identifier indicated in the first frame with an identifier indicated in the second frame. The method may include determining, by the first device based at least on a result of the comparing, whether the first device continues to associate with the first access point or associates with a software-enabled access point (soft-AP) configured in the second device.

In some embodiments, the first frame may be one of a beacon frame, a probe response frame, or a fast initial link setup (FILS) discovery frame. In some embodiments, the second frame may be a domain name system (DNS) frame or a multicast domain name system (mDNS) frame. In some embodiments, each of the identifier indicated in the first frame and the identifier indicated in the second frame may be a basic service set identifier (BSSID).

In some embodiments, the first device may determine whether a first field of the first frame is set to a first value indicating the soft-AP. In response to determining that the first field of the first frame is set to the first value, the first device may disassociate from the first access point and associate with the soft-AP. The first field of the first frame may include one of a vendor specific information element (VSIE), a short service set identifier (SSSID), or an organizationally unique identifier (OUI). The first device may determine whether a second field of the first frame is set to a second value indicating that the second device includes multiple radios. In response to determining that: (1) the first field of the first frame is set to the first value and (2) the second field of the first frame is set to the second value, the first device may disassociate from the first access point and associate with the soft-AP. In some embodiments, in response to determining that the first device associates with the soft-AP, the first device may add the identifier indicated in the first frame to a soft-AP list.

In some embodiments, the first device may wirelessly receiving, via the first access point, a third frame. The first device may determine whether an identifier indicated in the third frame is present in the soft-AP list. In response to determining that the identifier indicated in the third frame is present in the soft-AP list, the first device may disassociate from the first access point and associate with the soft-AP. In some embodiments, in response to determining that the identifier indicated in the third frame is not present in the soft-AP list, the first device may wirelessly receive, from the second device, a fourth frame, and determine whether a field of the fourth frame is set to a particular value indicating the soft-AP. In response to determining that the field of the fourth frame is set to the particular value, the first device may compare an identifier indicated in the fourth frame with an identifier indicated in the third frame. In response to determining that the identifier indicated in the fourth fame matches the identifier indicated in the third frame, the first device may add the identifier indicated in the third frame to the soft-AP list.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a diagram of a system environment including an AP, a software-enabled access point (soft-AP) and a client device, according to an example implementation of the present disclosure.

FIG. 5 is a flowchart showing a process of connecting to (or onboarding) a soft-AP, according to an example implementation of the present disclosure.

FIG. 6 is a flowchart showing a process of connecting to (or onboarding) a soft-AP, according to another example implementation of the present disclosure.

FIG. 7 is a flowchart showing a process of switching (or steering) from an AP to a soft-AP, according to an example implementation of the present disclosure.

FIG. 8 is a flowchart showing a process of determining whether a client device switches from an AP to a soft-AP or continues to associate with the AP, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

A Wi-Fi device (e.g., HWD) may be initially associated to an AP/router/gateway (referred to as “home AP” or “AP” hereinafter). When a device (e.g., laptop, desktop PC, tablet, smartphone) activates a software enabled access point (soft-AP) configuration, the HWD may need to make a decision on whether to (1) switch (onboard) from the home AP to the new soft-AP (for improved latency), or (2) continue its associated mode with the home AP. This decision may be critical from a performance point-of-view. For example, if the laptop has a single radio based Wi-Fi chipset, then the air time would be shared (e.g., via timed-division multiplexing) between its client mode of operation and soft-AP mode of operation, which would degrade an ongoing VR session if the HWD decides to switch/onboard from the home AP to the new soft-AP.

To address this problem, a HWD may use information in beacons the HWD receives, such as Vendor Specific Information Element (VSIE) and/or Short Service Set Identifier (SSSID), to associate with a newly activated soft-AP. According to certain aspects, embodiments in the present disclosure relate to techniques for a Wi-Fi device (e.g., HWD) to switch (or steer) from a home AP to a soft-AP which the HWD has previously associated with.

In some implementations, when an HWD receives a beacon from a soft-AP, the HWD may determine a first address (e.g., BSSID or MAC (medium access protocol) address) from the beacon based on a flag called “soft-AP” in a VSIE in the beacon. The HWD may determine a second address (BSSID or MAC address) using a domain name system (e.g., DNS or mDNS). In response to determining that the first address matches with the second address, the HWD may disconnect (and/or disassociate) from the current home AP and may associate with the soft-AP having the matched address. In some implementations, the HWD may determine the first address based on the soft-AP flag and another flag in a VSIE indicating that the device has a multi-radio, including 2.4 GHz, 5 GHz or 6 GHz radios, and may associate with a soft-AP of the device that has the first address and has the multi-radio. In some implementations, in response to determining that the first address matches with the second address, the HWD may add the matched address to a pre-stored soft-AP address list. In some implementations, the HWD may determine the first address based on both the soft-AP flag and another flag in VSIE indicating that the device has a multi-radio, including 2.4 GHz, 5 GHz or 6 GHz radios.

In some implementations, when an HWD receives a beacon from a soft-AP, it may determine a third address (e.g., BSSID or MAC address) from the beacon based on a short service set identifier (SSSID) in the beacon. A predetermined string indicating a soft-AP mode may be hard-coded in the SSSID and also hard-coded in a firmware of the HWD. After the HWD successfully pairs with an application on a device (e.g., VR application), the HWD may determine a fourth address (BSSID or MAC address) using a domain name system (e.g., DNS or mDNS). In response to determining that the third address matches with the fourth address, the HWD may disconnect (and/or disassociate) from the current home AP and can associate with the soft-AP having the matched address. In some implementations, the HWD may determine the third address based on (1) the SSSID indicating the soft-AP mode and (2) an SSSID indicating that the device has a multi-radio, including 2.4 GHz, 5 GHz or 6 GHz radios, and may associate with a soft-AP of the device that has the third address and has the multi-radio. In some implementations, in response to determining that the third address matches with the fourth address, the HWD may add the matched address to a pre-stored soft-AP address list.

In some implementations, when a user starts a soft-AP and launches an application on a device, the device may initiate or send a broadcast or multicast frame which includes a fifth address of the soft-AP. A HWD may receive the broadcast or multicast frame and can obtain the fifth address from the frame. In response to determining that the fifth address is in a pre-stored soft-AP address list, the HWD may disconnect (and/or disassociate) from the current AP and can associate with the soft-AP having the fifth address. Before disconnection from the current AP, the HWD may receive a beacon frame from the soft-AP to confirm the soft-AP is functioning correctly.

In one approach, a first device (e.g., a Wi-Fi device, a HWD) may connect to a soft-AP for the first time (e.g., initial onboarding) using a VSIE. Initially, the first device may be connected to (and/or associated with) an AP (e.g., a home AP). In some embodiments, the first device may use the AP for supporting/facilitating a VR/AR/MR application (e.g., remote rendering).

Next, the first device may receive beacons from a second device (e.g., a Wi-Fi device, a laptop or PC running a soft-AP). In some embodiments, the second device may turn on a hotspot or a soft-AP and can broadcast beacons including one or more VSIEs. A flag indicating a soft-AP (e.g., “soft-AP” flag) when set to 1 may be defined in a VSIE or other fields of a beacon frame. The soft-AP flag when set to 1 may be used to identify a network as a soft-AP network after the second device (e.g., PC) starts a hotspot or a soft-AP. In some embodiments, the second device may include a VSIE in frames other than beacons, such as probe response frames or fast initial link setup (FILS) discovery frames. In response to determining that the first device did/has not receive beacons from the second device, the first device may continue to use (or connected/associated with) the current AP (e.g., for remote rendering).

Next, the first device may determine whether (1) the received beacon includes a VSIE and (2) a soft-AP flag defined in the VSIE is set to 1 (or other value indicating a soft-AP or hotspot). In response to determining that the soft-AP flag defined in the VSIE is set to 1, the first device may obtain an identifier (e.g., BSSID) of the soft-AP from the beacon (e.g., BSSID field) and store, in a memory, the identifier as a first identifier string (referred to as “Associated_MAC”). In response to determining that (1) the received beacon does not include a VSIE or (2) a soft-AP flag defined in the VSIE is not set to 1, the first device may continue to use (or be connected/associated with) the current AP (e.g., for remote rendering).

Next, the first device (or an application running on the first device) may pair or connect with an application (e.g., VR/AR/MR application) running on the second device. The first device may obtain an identifier (e.g., BSSID) of the soft-AP from the second device using mDNS. For example, the second device may include the BSSID of the soft-AP network (or hotspot network) as a ‘TXT record’ in broadcast/multicast mDNS frames. The mDNS frames may be sent via the home AP and both the first device and the second device may be connected to or associated with the home AP for automatic switch. In response to determining that the first device obtains the BSSID of the soft-AP network from the mDNS frames, and the first device may store, in the memory, the obtained BSSID as a second identifier string (referred to as “Paired_MAC”). In response to determining that (1) the first device does not pair or connect with an application running on the second device or (2) the first device does not obtain an identifier (e.g., BSSID) of the soft-AP from the second device using mDNS, the first device may continue to use (or connected/associated with) the current AP (e.g., for remote rendering).

Next, the first device may determine whether the Associated_MAC matches Paired_MAC. In response to determining that the Associated_MAC matches Paired_MAC, the first device may add or append the matched BSSID to a soft-AP list (or SAP list) for later use. In some embodiments, the SAP list may be a list of pre-stored hotspot/soft-AP MAC addresses (stored in the first device). In some embodiments, the first device may disconnect or disassociate from the current (home) AP, and can associate with the soft-AP to use the soft-AP (e.g., for remote rendering). In response to determining that the Associated_MAC does not match Paired_MAC, the first device may continue to use (or be connected/associated with) the current AP (e.g., for remote rendering).

In some embodiments, a flag (referred to as “multi-radio flag”) indicating that the second device has a multi-radio, including 2.4 GHz, 5 GHz or 6 GHz radios, when set to 1 may be defined in a VSIE or other fields of a beacon frame. The multi-radio flag may be included in frames other than beacon frames, such as probe response FILS discovery frames. The multi-radio flag may be used to identify or determine whether the second device has multiple radios (when set to 1, for example) or a single radio (when set to 0, for example).

In some embodiments, the first device may determine whether (1) the received beacon includes a VSIE, (2) a soft-AP flag defined in the VSIE is set to 1, and (3) a multi-radio flag defined in the VSIE is set to 1. In response to determining that both the soft-AP flag and the multi-radio flag defined in the VSIE are set to 1, the first device may obtain an identifier (e.g., BSSID) of the soft-AP from the beacon (e.g., BSSID field) and can store, in the memory, the identifier as a first identifier string (referred to as “Associated_MAC”). In response to determining that (1) the received beacon does not include a VSIE, or (2) the soft-AP flag defined in the VSIE is not set to 1, or (3) the multi-radio flag defined in the VSIE is not set to 1, the first device may continue to use (or be connected/associated with) the current AP (e.g., for remote rendering). For example, even if the soft-AP flag is set to 1, when the multi-radio flag is set to 0, the first device may not store the BSSID of the soft-AP, because the soft-AP (or the second device) only has a single radio.

In one approach, a first device (e.g., a Wi-Fi device, a HWD) may connect to a soft-AP for the first time (e.g., initial onboarding) using a short service set identifier (SSSID). Initially, the first device may be connected to (and/or associated with) an AP (e.g., a home AP). In some embodiments, the first device may use the AP for an XR (e.g., VR/AR/MR) application (e.g., remote rendering).

Next, the first device may receive beacons from a second device (e.g., a Wi-Fi device, a laptop or PC running a soft-AP). In some embodiments, the second device may turn on a hotspot or a soft-AP and can broadcast beacons including one or more SSSIDs. In some embodiments, a hard-coded string (e.g. “Meta”) can be used as a SSSID in the beacons broadcasted by the second device (e.g., PC) after starting a soft-AP or hotspot. The same string may also be hard-coded in the first device (e.g., in firmware of the first device) so that the first device can check for the string in received beacons.

Next, the first device may determine whether (1) the received beacon includes a SSSID and (2) the string used as the SSSID in the received beacon matches the string hard-coded in the first device. In response to determining that the string used as the SSSID matches the string hard-coded in the first device, the first device may obtain an identifier (e.g., BSSID) of the soft-AP from the beacon (e.g., BSSID field) and can store, in a memory, the identifier as a first identifier string (referred to as “Associated_MAC”). In response to determining that (1) the received beacon does not include a SSSID or (2) the string used as the SSSID in the received beacon does not match the string hard-coded in the first device, the first device may continue to use (or be connected/associated with) the current AP (e.g., for remote rendering).

In some embodiments, organizationally unique identifiers (OUIs) may be used instead of SSSIDs to identify a soft-AP or hotspot. For example, the second device may turn on a hotspot or a soft-AP and can broadcast beacons (or other broadcast frames) including one or more OUIs. In some embodiments, a particular value may be used as an OUI in the beacons broadcasted by the second device (e.g., PC) after starting a soft-AP or hotspot. The same value may also be hard-coded in the first device (e.g., in firmware of the first device) so that the first device may check for the value in received beacons. For example, in response to determining that the value used as the OUI matches the value hard-coded in the first device, the first device may obtain an identifier (e.g., BSSID) of the soft-AP from the beacon (e.g., BSSID field) and can store, in a memory, the identifier as “Associated_MAC”.

Next, the first device (or an application running on the first device) may pair or connect with an application (e.g., VR/AR/MR application) running on the second device. The first device may obtain an identifier (e.g., BSSID) of the soft-AP from the second device using mDNS. For example, the second device may include the BSSID of the soft-AP network (or hotspot network) as a ‘TXT record’ in broadcast/multicast mDNS frames. The mDNS frames may be sent via the home AP and both the first device and the second device may be connected to or associated with the home AP for automatic switch. In response to determining that the first device obtains the BSSID of the soft-AP network from the mDNS frames, and the first device may store, in the memory, the obtained BSSID as a second identifier string (referred to as “Paired_MAC”). In response to determining that (1) the first device does not pair or connect with an application running on the second device or (2) the first device does not obtain an identifier (e.g., BSSID) of the soft-AP from the second device using mDNS, the first device may continue to use (or connected/associated with) the current AP (e.g., for remote rendering).

Next, the first device may determine whether the Associated_MAC matches Paired_MAC. In response to determining that the Associated_MAC matches Paired_MAC, the first device may add or append the matched BSSID to a soft-AP list (or SAP list) for later use. In some embodiments, the SAP list may be a list of pre-stored hotspot/soft-AP MAC addresses (stored in the first device). In some embodiments, the first device may disconnect or disassociate from the current (home) AP, and can associate with the soft-AP to use the soft-AP (e.g., for remote rendering). In response to determining that the Associated_MAC does not match Paired_MAC, the first device may continue to use (or connected/associated with) the current AP (e.g., for remote rendering).

In some embodiments, two hard-coded strings (e.g. “Meta1” and “Meta2”) may be used to indicate that the second device has a single radio or a multi-radio, including 2.4 GHz, 5 GHz or 6 GHz radios, respectively. For example, one string may be selected from the two hard-coded strings depending on the number of radios the second devices has, and the selected string may be used as a SSSID in the beacons broadcasted by the second device (e.g., PC) after starting a soft-AP or hotspot. The same two strings may also be hard-coded in the first device (e.g., in firmware of the first device) so that the first device can check for either string in received beacons. The two hard-coded strings may be used to identify or determine whether the second device has multiple radios (when the SSSID is “Meta2”, for example) or a single radio (when the SSSID is “Meta1”, for example).

In some embodiments, two particular values (e.g., v1 and v2) as OUIs may be used to indicate that the second device has a single radio or a multi-radio, including 2.4 GHz, 5 GHz or 6 GHz radios, respectively. For example, one value may be selected from the two particular values depending on the number of radios the second devices has, and the selected value may be used as an OUI in the beacons broadcasted by the second device (e.g., PC) after starting a soft-AP or hotspot. The same two values (e.g., v1 and v2) may also be hard-coded in the first device (e.g., in firmware of the first device) so that the first device can check for either value in received beacons. The two hard-coded values may be used to identify or determine whether the second device has multiple radios (when the OUI is v2, for example) or a single radio (when the OUI is v1, for example).

In some embodiments, the first device may determine whether (1) the received beacon includes a SSSID, and (2) the SSSID in the received beacon matches a string indicating that the second device has a multi-radio, including 2.4 GHz, 5 GHz or 6 GHz radios. In some embodiments, OUIs may be used instead of SSSIDs. In response to determining that the SSSID in the received beacon matches the string indicating that the second device has a multi-radio, including 2.4 GHz, 5 GHz or 6 GHz radios, the first device may obtain an identifier (e.g., BSSID) of the soft-AP from the beacon (e.g., BSSID field) and can store, in the memory, the identifier as a first identifier string (referred to as “Associated_MAC”). In response to determining that (1) the received beacon does not include a SSSID, or (2) the SSSID in the received beacon does not match the string indicating that the second device has a multi-radio, including 2.4 GHz, 5 GHz or 6 GHz radios, the first device may continue to use (or connected/associated with) the current AP (e.g., for remote rendering). For example, if the SSSID in the received beacon does not match the string indicating that the second device has a multi-radio, including 2.4 GHz, 5 GHz or 6 GHz radios (e.g., the SSSID in the received beacon instead matches the string indicating that the second device has a single radio), the first device may not store the BSSID of the soft-AP, because the soft-AP (or the second device) only has a single radio.

In one approach, a first device (e.g., a Wi-Fi device, a HWD) may switch (or steer/transition) from an AP to a soft-AP, according to an example implementation of the present disclosure. Initially, the first device may be connected to (and/or associated with) an AP (e.g., a home AP). In some embodiments, the first device may use the AP for a VR/AR/MR application (e.g., remote rendering).

Next, a second device (e.g., PC) may start (e.g., by user operations) a soft-AP and/or hotspot on the second device and/or may launch an application (e.g., VR/AR/MR app). The second device may initiate or broadcast an mDNS frame which may include an identifier (e.g., BSSID) of the soft-AP interface and/or hotspot interface as a ‘TXT record’ so that the first device can receive the mDNS frame. The mDNS frames may be sent via the home AP and both the first device and the second device may be connected to or associated with the home AP for automatic switch. In response to determining that the first device receives an mDNS frame from the second device, the first device may obtain an identifier (e.g., BSSID) of the soft-AP from the mDNS frame. In response to determining that the first device does not receive an mDNS frame or the first device does not obtain an identifier (e.g., BSSID) of the soft-AP from an mDNS frame, the first device may continue to use (or be connected/associated with) the current AP (e.g., for remote rendering).

Next, the first device may determine whether the BSSID of the soft-AP obtained from the mDNS frame is present in a soft-AP list (or SAP list). In some embodiments, the SAP list may be a list of pre-stored hotspot/soft-AP MAC addresses (stored in the first device). In response to determining that the BSSID of the soft-AP obtained from the mDNS frame is present in the SAP list, the first device may disconnect or disassociate from the current (home) AP, and can associate with the soft-AP whose BSSID is present (or matched with an address) in the SAP list to use the soft-AP (e.g., for remote rendering). Before disconnection from the home AP, the first device may receive a beacon frame from the soft-AP to confirm the soft-AP is functioning correctly.

In response to determining that the BSSID of the soft-AP obtained from the mDNS frame is not present in the SAP list, the first device may determine, based on a beacon received from the second device, whether the first device is to connect or associate with a soft-AP in the second device. The first device may use any of the methods described above that can detect or identify a BSSID of a new soft-AP in the onboarding scenario. For example, the first device may determine whether (1) the received beacon includes a VSIE and (2) a soft-AP flag defined in the VSIE is set to 1 (or other value indicating a soft-AP or hotspot). The first device may determine whether (1) the received beacon includes a SSSID and (2) the string used as the SSSID in the received beacon matches the string hard-coded in the first device. The first device may determine whether (1) the received beacon includes an OUI and (2) the value used as the OUI matches the value hard-coded in the first device. The first device may determine whether (1) the received beacon includes a VSIE, (2) a soft-AP flag defined in the VSIE is set to 1, and (3) a multi-radio flag defined in the VSIE is set to 1. The first device may determine whether (1) the received beacon includes a SSSID, and (2) the SSSID in the received beacon matches a string indicating that the second device has a multi-radio, including 2.4 GHz, 5 GHz or 6 GHz radios. In some embodiments, OUIs may be used instead of SSSIDs. In response to determining that the first device does not detect any soft-AP, the first device may continue to use (or be connected/associated with) the current AP (e.g., for remote rendering).

Next, in response to obtaining a BSSID of the new soft-AP in the second device, the first device may compare the BSSID of the soft-AP with the BSSID of the soft-AP obtained from the mDNS frame. In response to determining that the BSSID of the soft-AP matches the BSSID of the soft-AP obtained from the mDNS frame, the first device may append the obtained BSSID to the SAP list. The first device may then disconnect or disassociate from the current (home) AP, and can associate with the soft-AP whose BSSID is present (or matched with an address) in the SAP list to use the soft-AP (e.g., for remote rendering).

In one approach, a first device connected in a wireless local area network (WLAN) may include one or more processors. The one or more processors may associate with a first access point (e.g., home access point). The one or more processors may wirelessly receive, via a transceiver from a second device, a first frame. The one or more processors may wirelessly receive, via the first access point, a second frame. The one or more processors may compare an identifier indicated in the first frame with an identifier indicated in the second frame. The one or more processors may determine, based at least on a result of the comparing, whether the first device continues to associate with the first access point or associates with a software-enabled access point (soft-AP) configured in the second device.

In some embodiments, the first frame may be one of a beacon frame, a probe response frame, or a fast initial link setup (FILS) discovery frame. In some embodiments, the second frame may be a domain name system (DNS) frame or a multicast domain name system (mDNS) frame. In some embodiments, each of the identifier indicated in the first frame and the identifier indicated in the second frame may be a basic service set identifier (BSSID).

In some embodiments, the one or more processors may be further configured to determine whether a first field of the first frame is set to a first value. In response to determining that the first field of the first frame is set to the first value, the one or more processors may be configured to disassociate from the first access point and associate with the soft-AP. The first field of the first frame may include one of a vendor specific information element (VSIE), a short service set identifier (SSSID), or an organizationally unique identifier (OUI). The one or more processors may be further configured to determine whether a second field of the first frame is set to a second value indicating that the second device includes multiple radios. In response to determining that: (1) the first field of the first frame is set to the first value and (2) the second field of the first frame is set to the second value, the one or more processors may be configured to disassociate from the first access point and associate with the soft-AP. In some embodiments, in response to determining that the first device associates with the soft-AP, the one or more processors may be configured to add the identifier indicated in the first frame to a soft-AP list.

In some embodiments, the one or more processors may be further configured to wirelessly receive, via the first access point (e.g., home access point), a third frame. The one or more processors may be configured to determine whether an identifier indicathed in the third frame is present in the soft-AP list. In response to determining that the identifier indicated in the third frame is present in the soft-AP list, the one or more processors may be configured to disassociate from the first access point and associate with the soft-AP. In response to determining that the identifier indicated in the third frame is not present in the soft-AP list, the one or more processors may be further configured to wirelessly receive, from the second device, a fourth frame, and determine whether a field of the fourth frame is set to a particular value indicating the soft-AP. In response to determining that the field of the fourth frame is set to the particular value, the one or more processors may be configured to compare an identifier indicated in the fourth frame with an identifier indicated in the third frame. In response to determining that the identifier indicated in the fourth fame matches the identifier indicated in the third frame, the one or more processors may be configured to add the identifier indicated in the third frame to the soft-AP list.

Embodiments in the present disclosure have at least the following advantages and benefits. First, embodiments in the present disclosure can provide useful techniques for a first device (e.g., HWD) to connect to (or onboarding) a soft-AP for the first time using a VSIE or SSSID or OUI in beacons, according to an example implementation of the present disclosure. The first device can make a decision to onboard a soft-AP in consideration of a performance point-of-view. For example, if a second device (e.g., PC or laptop) running a soft-AP has a single radio based Wi-Fi chipset, then the first device may not onboard the soft-AP. On the other hand, if the second device has a multi-radio (e.g., dual radio) based Wi-Fi chipset, then the first device may onboard the soft-AP, thereby providing a dedicated connection between the first device and the second device on a specific channel (e.g., 5 GHz), which may be different from a channel (e.g., 2.4 GHz) for connection between the second device and a home AP.

Second, embodiments in the present disclosure can provide useful techniques for a device to switch (or steer) from an AP to a soft-AP, according to another example implementation of the present disclosure. The first device can efficiently switch (or steer) from the current AP (e.g., home AP) to a soft-AP using a pre-stored soft-AP (SAP) list. For example, in response to determining that the BSSID of the soft-AP is present in the SAP list, the first device can steer to the soft-AP without identifying or detecting the soft-AP using beacons.

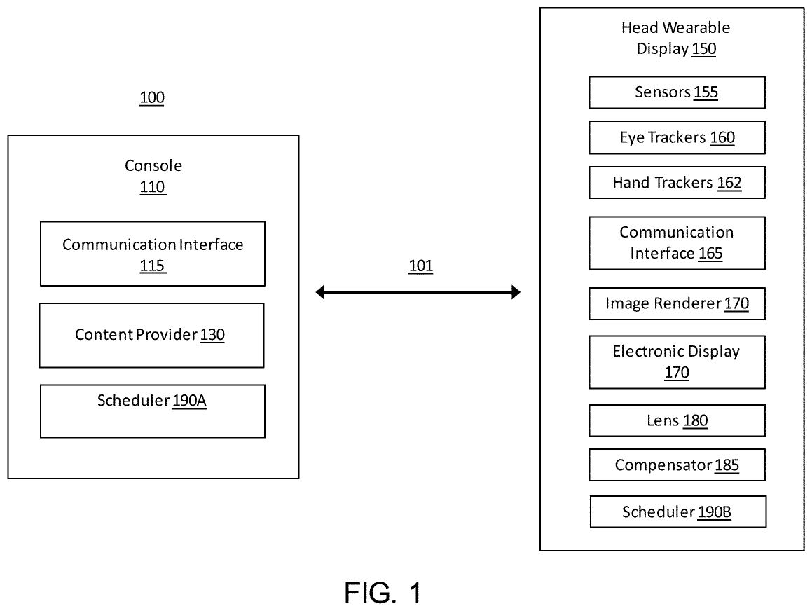

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

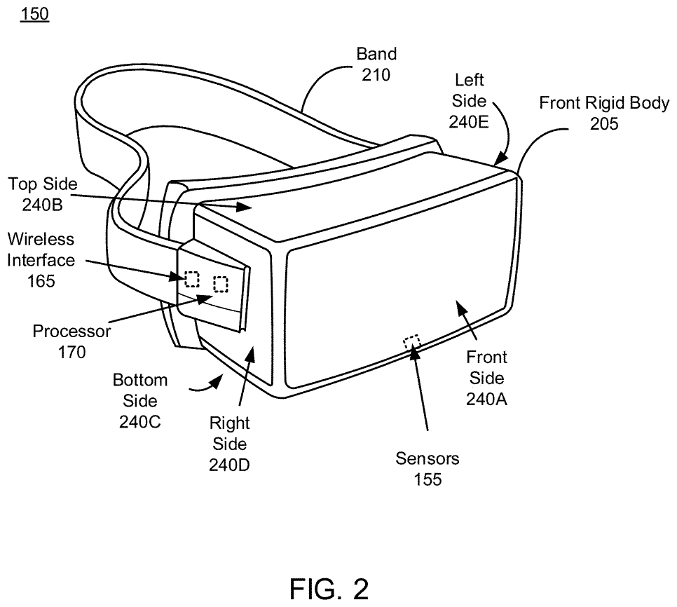

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

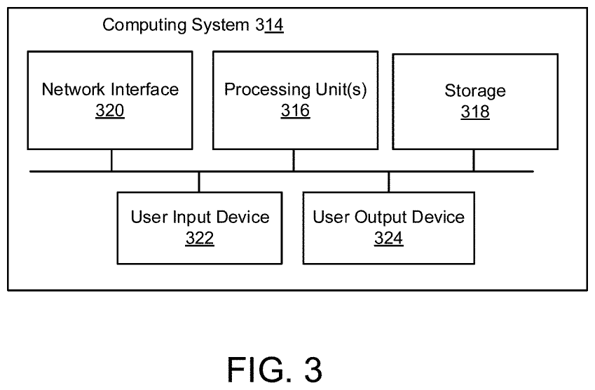

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

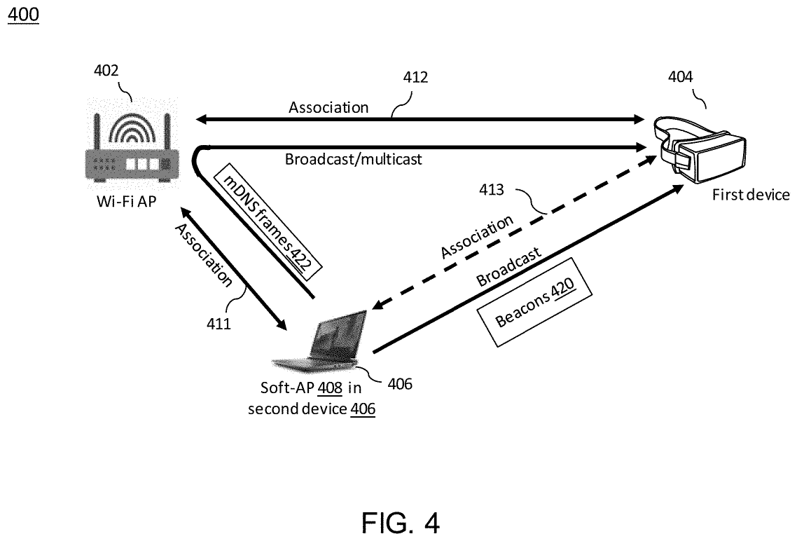

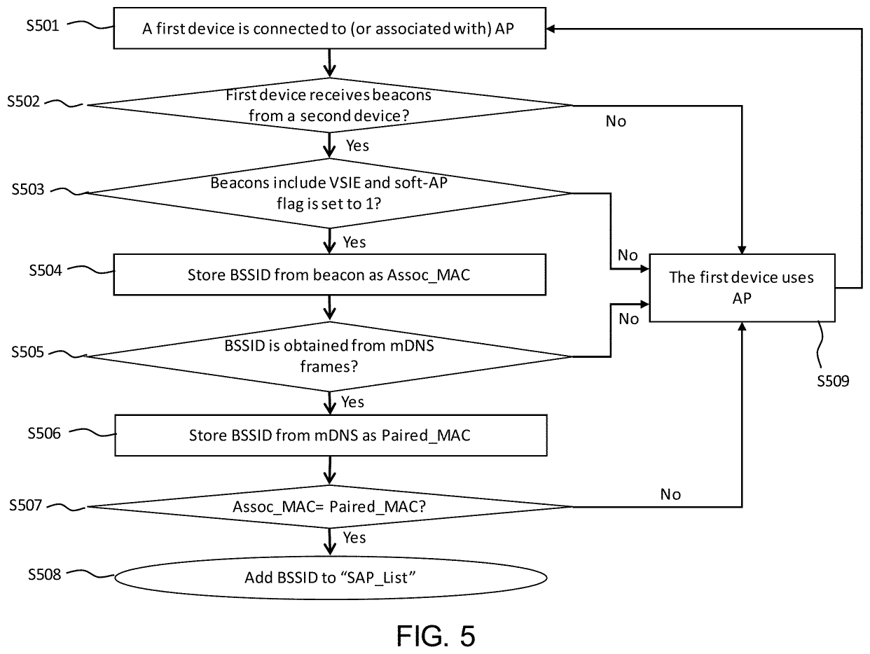

FIG. 4 is a diagram of a system environment including an AP (or home AP) 402, a first device 404, and a software-enabled access point (soft-AP) 408 in a second device 406, according to an example implementation of the present disclosure. The AP may be a router/gateway. The first device 404 may be a Wi-Fi device such as an HWD. The second device 406 may be a Wi-Fi device such as laptop, desktop PC, tablet, smartphone. The second device 406 may be connected or associated with the AP 402 (association 411). The first client device may initially be connected or associated 412 with the AP 402 (association 412). When the second device 406 turns on the soft-AP (or hotspot) 408, the first client device may determine whether the first device switches (or onboards, steers) from the AP 402 to the soft AP 408 (association 413) or continues to associate with the AP 402 (association 412). The first device may make the onboarding/steering determination using beacons 420 or mDNS frames 422, broadcast or multicast via the first access point 402 (e.g., home access point). Details of the onboarding/steering methods will be described below with reference to FIG. 5 to FIG. 8.

FIG. 5 is a flowchart showing a process of connecting to a soft-AP (e.g., soft-AP 408 in FIG. 4) for the first time (e.g., initial onboarding) using a VSIE, according to an example implementation of the present disclosure. Initially, at step S501, a first device (e.g., first device 404 in FIG. 4) may be connected to (and/or associated with) an AP (e.g., AP 402 in FIG. 4). In some embodiments, the first device 404 may use the AP 402 for a VR/AR/MR application (e.g., remote rendering).

At step S502, the first device 404 may receive beacons (e.g., beacons 420 in FIG. 4) from a second device (e.g., second device 406 in FIG. 4). In some embodiments, the second device 406 may turn on a hotspot or a soft-AP 408 and can broadcast beacons 420 including one or more VSIEs. A soft-AP flag indicating a soft-AP when set to 1 may be defined in a VSIE or other fields of a beacon frame. The soft-AP flag when set to 1 may be used to identify a network as a soft-AP network after the second device 406 starts the hotspot or soft-AP 408. In some embodiments, the second device 406 may include a VSIE in frames other than beacon beacons, such as probe response frames or FILS discovery frames. In response to determining that the first device 404 does not receive beacons from the second device 406, the first device 404 may continue to use (or connected/associated with) the current AP 402 (e.g., for remote rendering).

At step S503, the first device 404 may determine whether (1) the received beacon includes a VSIE and (2) a soft-AP flag defined in the VSIE is set to 1 (or other value indicating a soft-AP or hotspot). In response to determining that the soft-AP flag defined in the VSIE is set to 1, the first device 404 may obtain an identifier (e.g., BSSID) of the soft-AP 408 from the beacon 420 (e.g., BSSID field) and can store, in a memory, the identifier as a first identifier string (referred to as “Associated_MAC”) at step S504. In response to determining that (1) the received beacon does not include a VSIE or (2) a soft-AP flag defined in the VSIE is not set to 1, the first device 404 may continue to use (or be connected/associated with) the current AP 402 (e.g., for remote rendering) at step S509.

At step S505, the first device 404 (or an application running on the first device) may pair or connect with an application (e.g., VR/AR/MR application) running on the second device 406. The first device 404 may obtain an identifier (e.g., BSSID) of the soft-AP 408 from the second device 406 using mDNS. For example, the second device 406 may include the BSSID of the soft-AP network (or hotspot network) as a ‘TXT record’ in broadcast/multicast mDNS frames 422. The mDNS frames 422 may be sent via the home AP 402 and both the first device 404 and the second device 406 may be connected to or associated with the home AP 402 for automatic switch. In response to determining that the first device 404 obtains the BSSID of the soft-AP network from the mDNS frames 422, and the first device 404 may obtain the BSSID of the soft-AP network from the mDNS frames 422 and may store, in the memory, the obtained BSSID as a second identifier string (referred to as “Paired_MAC”) at step S506. In response to determining that (1) the first device 404 does not pair or connect with an application running on the second device 406 or (2) the first device 404 does not obtain an identifier (e.g., BSSID) of the soft-AP 408 from the second device 406 using mDNS, the first device 404 may continue to use (or be connected/associated with) the current AP 402 (e.g., for remote rendering) at step S509.

At step S507, the first device 404 may determine whether the Associated_MAC matches Paired_MAC. In response to determining that the Associated_MAC matches Paired_MAC, the first device 404 may add or append the matched BSSID to a soft-AP list (or SAP list) for later use at step S508. In some embodiments, the SAP list may be a list of pre-stored hotspot/soft-AP MAC addresses (stored in the first device). In some embodiments, the first device 404 may disconnect or disassociate from the current (home) AP 402, and can associate with the soft-AP 408 to use the soft-AP 408 (e.g., for remote rendering). In response to determining that the Associated_MAC does not match Paired_MAC, the first device 404 may continue to use (or connected/associated with) the current AP 402 (e.g., for remote rendering) at step S509.

In some embodiments, a multi-radio flag indicating that the second device has a multi-radio, including 2.4 GHz, 5 GHz or 6 GHz radios, when set to 1 may be defined in a VSIE or other fields of a beacon frame 420. The multi-radio flag may be included in frames other than beacon frames, such as probe response FILS discovery frames. The multi-radio flag may be used to identify or determine whether the second device 406 has multiple radios (when set to 1, for example) or a single radio (when set to 0, for example).

In some embodiments, the first device 404 may determine whether (1) the received beacon 420 includes a VSIE, (2) a soft-AP flag defined in the VSIE is set to 1, and (3) a multi-radio flag defined in the VSIE is set to 1. In response to determining that both the soft-AP flag and the multi-radio flag defined in the VSIE are set to 1, the first device 404 may obtain an identifier (e.g., BSSID) of the soft-AP 408 from the beacon (e.g., BSSID field) and store, in the memory, the identifier as a first identifier string (referred to as “Associated_MAC”). In response to determining that (1) the received beacon 420 does not include a VSIE, or (2) the soft-AP flag defined in the VSIE is not set to 1, or (3) the multi-radio flag defined in the VSIE is not set to 1, the first device 404 may continue to use (or connected/associated with) the current AP 402 (e.g., for remote rendering). For example, even if the soft-AP flag is set to 1, when the multi-radio flag is set to 0, the first device 404 may not store the BSSID of the soft-AP 408, because the soft-AP (or the second device) only has a single radio.

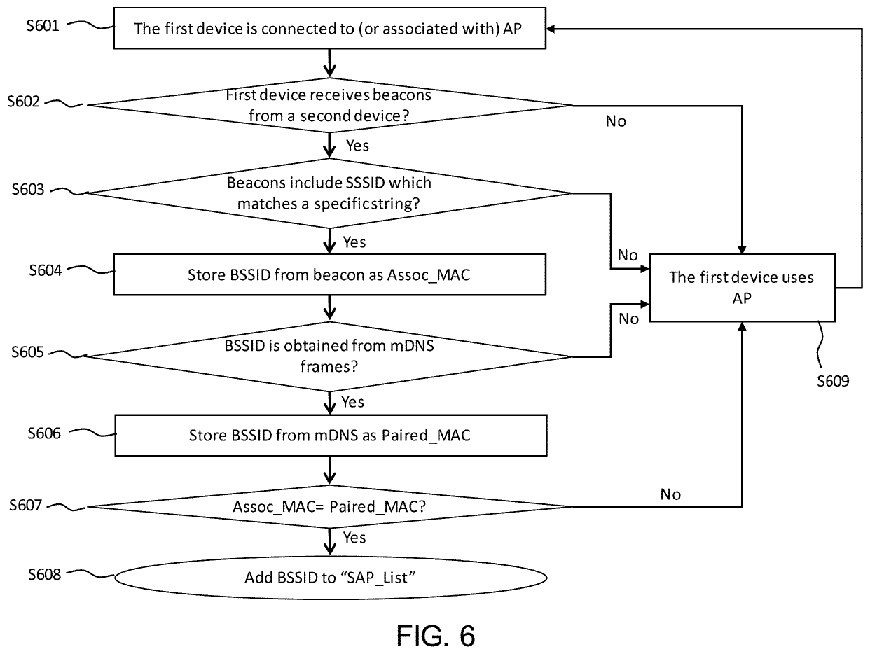

FIG. 6 is a flowchart showing a process of connecting to a soft-AP (e.g., soft-AP 408 in FIG. 4) for the first time (e.g., initial onboarding) using a short service set identifier (SSSID) or organizationally unique identifiers (OUIs), according to another example implementation of the present disclosure. Initially, at step S601, a first device (e.g., first device 404 in FIG. 4) may be connected to (and/or associated with) an AP (e.g., a home AP 402 in FIG. 4). In some embodiments, the first device 404 may use the AP 402 for a VR/AR/MR application (e.g., remote rendering).

At step S602, the first device 404 may receive beacons (e.g., beacons 420 in FIG. 4) from a second device (e.g., second device 406 in FIG. 4). In some embodiments, the second device 406 may turn on a hotspot or a soft-AP 408 and broadcast beacons 420 including one or more SSSIDs. In some embodiments, a hard-coded string (e.g. “Meta”) can be used as a SSSID in the beacons 420 broadcasted by the second device 406 after starting the soft-AP or hotspot 408. The same string may also be hard-coded in the first device 404 (e.g., in firmware of the first device) so that the first device 404 can check for the string in received beacons 420.

At step S603, the first device 404 may determine whether (1) the received beacon 420 includes a SSSID and (2) the string used as the SSSID in the received beacon 420 matches the string hard-coded in the first device 404. In response to determining that the string used as the SSSID matches the string hard-coded in the first device, the first device 404 may obtain an identifier (e.g., BSSID) of the soft-AP from the beacon 420 (e.g., BSSID field) and can store, in a memory, the identifier as a first identifier string (referred to as “Associated_MAC”) at step S604. In response to determining that (1) the received beacon 420 does not include a SSSID or (2) the string used as the SSSID in the received beacon does not match the string hard-coded in the first device, the first device may continue to use (or be connected/associated with) the current AP (e.g., for remote rendering) at S609.

In some embodiments, OUIs may be used instead of SSSIDs to identify a soft-AP or hotspot. For example, the second device 406 may turn on a hotspot or a soft-AP 408 and broadcast beacons (or other broadcast frames) including one or more OUIs. In some embodiments, a particular value may be used as an OUI in the beacons 420 broadcasted by the second device 406 after starting a soft-AP or hotspot 408. The same value may also be hard-coded in the first device 404 (e.g., in firmware of the first device) so that the first device 404 may check for the value in received beacons. For example, in response to determining that the value used as the OUI matches the value hard-coded in the first device, the first device 404 may obtain an identifier (e.g., BSSID) of the soft-AP from the beacon (e.g., BSSID field) and can store, in a memory, the identifier as “Associated_MAC”.

At step S605, the first device 404 (or an application running on the first device 404) may pair or connect with an application (e.g., VR/AR/MR application) running on the second device 406. The first device 404 may obtain an identifier (e.g., BSSID) of the soft-AP 408 from the second device 406 using mDNS. For example, the second device 406 may include the BSSID of the soft-AP network (or hotspot network) as a ‘TXT record’ in broadcast/multicast mDNS frames 422. The mDNS frames 422 may be sent via the home AP 402 and both the first device 404 and the second device 406 may be connected to or associated with the home AP 402 for automatic switch. In response to determining that the first device 404 obtains the BSSID of the soft-AP network from the mDNS frames 422, and the first device 404 may store, in the memory, the obtained BSSID as a second identifier string (referred to as “Paired_MAC”) at step S606. In response to determining that (1) the first device 404 does not pair or connect with an application running on the second device 406 or (2) the first device 404 does not obtain an identifier (e.g., BSSID) of the soft-AP from the second device 406 using mDNS, the first device 404 may continue to use (or be connected/associated with) the current AP 402 (e.g., for remote rendering).

At step S607, the first device 404 may determine whether the Associated_MAC matches Paired_MAC. In response to determining that the Associated_MAC matches Paired_MAC, the first device 404 may add or append the matched BSSID to a soft-AP list (or SAP list) for later use. In some embodiments, the SAP list may be a list of pre-stored hotspot/soft-AP MAC addresses (stored in the first device). In some embodiments, the first device 404 may disconnect or disassociate from the current (home) AP 402, and can associate with the soft-AP 408 to use the soft-AP 408 (e.g., for remote rendering). In response to determining that the Associated_MAC does not match Paired_MAC, the first device 404 may continue to use (or be connected/associated with) the current AP 402 (e.g., for remote rendering) at step S609.

In some embodiments, two hard-coded strings (e.g. “Meta1” and “Meta2”) may be used to indicate that the second device 406 has a single radio or a multi-radio, including 2.4 GHz, 5 GHz or 6 GHz radios, respectively. For example, one string may be selected from the two hard-coded strings depending on the number of radios the second devices 406 has, and the selected string may be used as a SSSID in the beacons 420 broadcasted by the second device 406 after starting a soft-AP or hotspot 408. The same two strings may also be hard-coded in the first device 404 (e.g., in firmware of the first device) so that the first device 404 can check for either string in received beacons 420. The two hard-coded strings may be used to identify or determine whether the second device 406 has a multi-radio (when the SSSID is “Meta2”, for example) or a single radio (when the SSSID is “Meta1”, for example).

In some embodiments, two particular values (e.g., v1 and v2) as OUIs may be used to indicate that the second device has a single radio or a multi-radio, including 2.4 GHz, 5 GHz or 6 GHz radios, respectively. For example, one value may be selected from the two particular values depending on the number of radios the second devices has, and the selected value may be used as an OUI in the beacons 420 broadcasted by the second device 406 after starting a soft-AP or hotspot 408. The same two values (e.g., v1 and v2) may also be hard-coded in the first device 404 (e.g., in firmware of the first device) so that the first device 404 can check for either value in received beacons 420. The two hard-coded values may be used to identify or determine whether the second device 406 has a multi-radio (when the OUI is v2, for example) or a single radio (when the OUI is v1, for example).

In some embodiments, the first device 404 may determine whether (1) the received beacon 420 includes a SSSID, and (2) the SSSID in the received beacon matches a string indicating that the second device 406 has a multi-radio, including 2.4 GHz, 5 GHz or 6 GHz radios. In some embodiments, OUIs may be used instead of SSSIDs. In response to determining that the SSSID in the received beacon matches the string indicating that the second device has a multi-radio, including 2.4 GHz, 5 GHz or 6 GHz radios, the first device 404 may obtain an identifier (e.g., BSSID) of the soft-AP 408 from the beacon 420 (e.g., BSSID field) and can store, in the memory, the identifier as a first identifier string (referred to as “Associated_MAC”) at step S604. In response to determining that (1) the received beacon does not include a SSSID, or (2) the SSSID in the received beacon does not match the string indicating that the second device has a multi-radio, including 2.4 GHz, 5 GHz or 6 GHz radios, the first device may continue to use (or be connected/associated with) the current AP (e.g., for remote rendering) at step S609. For example, if the SSSID in the received beacon does not match the string indicating that the second device has a multi-radio, including 2.4 GHz, 5 GHz or 6 GHz radios (e.g., the SSSID in the received beacon instead matches the string indicating that the second device has a single radio), the first device 404 may not store the BSSID of the soft-AP, because the soft-AP 408 (or the second device 406) only has a single radio.

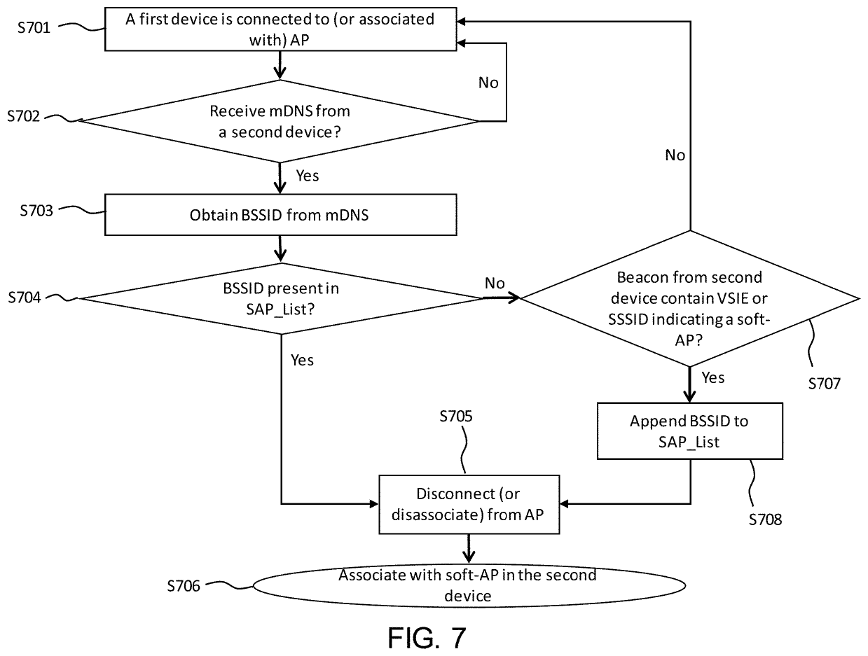

FIG. 7 is a flowchart showing a process of switching (or steering) from an AP (e.g., AP 402 in FIG. 4) to a soft-AP (e.g., soft-AP 408), according to an example implementation of the present disclosure. Initially, at step S701, a first device (e.g., first device 404 in FIG. 4) may be connected to (and/or associated with) the AP 402. In some embodiments, the first device 404 may use the AP 402 for a VR/AR/MR application (e.g., remote rendering). A second device (e.g., second device 406) may start (e.g., by user operations) a soft-AP 408 and/or hotspot on the second device 406 and/or launch an application (e.g., VR/AR/MR app). The second device 406 may initiate or broadcast an mDNS frame 422 which may include an identifier (e.g., BSSID) of the soft-AP interface and/or hotspot interface as a ‘TXT record’ so that the first device 404 can receive the mDNS frame 422. The mDNS frames 422 may be sent via the home AP 402 and both the first device 404 and the second device 406 may be connected to or associated with the home AP 402 for automatic switch.

At step S702, the first device 404 may determine whether the first device 404 receives an mDNS frame 422 from the second device 406. In response to determining that the first device receives an mDNS frame from the second device, the first device 404 may obtain an identifier (e.g., BSSID) of the soft-AP from the mDNS frame 422 at step S703. In response to determining that the first device does not receive an mDNS frame or the first device does not obtain an identifier (e.g., BSSID) of the soft-AP from an mDNS frame, the first device 404 may continue to use (or connected/associated with) the current AP 402 (e.g., for remote rendering) at step S701.

At step S704, the first device 404 may determine whether the BSSID of the soft-AP 408 obtained from the mDNS frame 422 is present in a soft-AP list (or SAP list). In some embodiments, the SAP list may be a list of pre-stored hotspot/soft-AP MAC addresses (stored in the first device 404). In response to determining that the BSSID of the soft-AP obtained from the mDNS frame is present in the SAP list, the first device 404 may disconnect or disassociate from the current (home) AP at step S705, and associate with the soft-AP 408 whose BSSID is present (or matched with an address) in the SAP list to use the soft-AP 408 (e.g., for remote rendering) at step S706. Before disconnection from the home AP 402, the first device 404 may receive a beacon frame 420 from the soft-AP 408 to confirm the soft-AP is functioning correctly.

At step S707, in response to determining that the BSSID of the soft-AP obtained from the mDNS frame is not present in the SAP list, the first device 404 may determine, based on a beacon received from the second device, whether the first device is to connect or associate with a soft-AP in the second device. The first device 404 may use any of the methods described above that can detect or identify a BSSID of a new soft-AP in the onboarding scenario. For example, the first device 404 may determine whether (1) the received beacon 420 includes a VSIE and (2) a soft-AP flag defined in the VSIE is set to 1 (or other value indicating a soft-AP or hotspot). The first device 404 may determine whether (1) the received beacon 420 includes a SSSID and (2) the string used as the SSSID in the received beacon matches the string hard-coded in the first device 404. The first device 404 may determine whether (1) the received beacon 420 includes an OUI and (2) the value used as the OUI matches the value hard-coded in the first device. The first device 404 may determine whether (1) the received beacon 420 includes a VSIE, (2) a soft-AP flag defined in the VSIE is set to 1, and (3) a multi-radio flag defined in the VSIE is set to 1. The first device 404 may determine whether (1) the received beacon 420 includes a SSSID, and (2) the SSSID in the received beacon 420 matches a string indicating that the second device has a multi-radio, including 2.4 GHz, 5 GHz or 6 GHz radios. In some embodiments, OUIs may be used instead of SSSIDs. In response to determining that the first device does not detect any soft-AP, the first device may continue to use (or be connected/associated with) the current AP (e.g., for remote rendering) at step S701.

At step S708, in response to obtaining a BSSID of the new soft-AP 408 in the second device 406, the first device may compare the BSSID of the soft-AP 408 with the BSSID of the soft-AP obtained from the mDNS frame 422. In response to determining that the BSSID of the soft-AP matches the BSSID of the soft-AP obtained from the mDNS frame, the first device 404 may append or add the obtained BSSID to the SAP list for later use. The first device 404 may then disconnect or disassociate from the current (home) AP 402 at step S705, and associate with the soft-AP 408 to use the soft-AP (e.g., for remote rendering) at step S706.

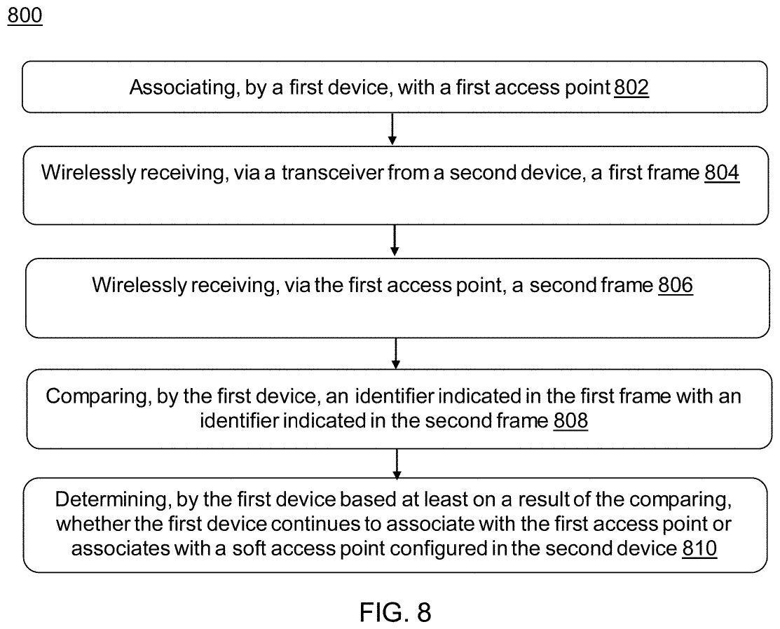

FIG. 8 is a flowchart showing a process of determining whether a first device (e.g., first device 404 in FIG. 4) switches from a first access point (e.g., home AP 402) to a soft access point (soft-AP) in a second device (e.g., soft-AP 408 in second device 406 in FIG. 4) or continues to associate with the first access point 402, according to an example implementation of the present disclosure. In some embodiments, the process 800 is performed by other entities. In some embodiments, the process 800 includes more, fewer, or different steps than shown in FIG. 8.

In one approach, the first device 404 may associate 802 with the first access point 402. In one approach, the first device 404 may wirelessly receive 804, via a transceiver (e.g., network interface 320) from the second device 406, a first frame 420. In some embodiments, the first frame 420 may be one of a beacon frame, a probe response frame, or a FILS discovery frame.

In one approach, the first device 404 may wirelessly receive 806, via the first access point 402, a second frame 422. In some embodiments, the second frame 422 may be an mDNS frame. In one approach, the first device 404 may compare 808 an identifier (e.g., BSSID) indicated in the first frame 420 with an identifier (e.g., BSSID) indicated in the second frame 422. In some embodiments, each of the identifier indicated in the first frame and the identifier indicated in the second frame may be a BSSID.

In one approach, the first device 404 may determine 810, based at least on a result of the comparing, whether the first device continues to associate with the first access point or associates with a soft-AP 408 configured in the second device 406. For example, in response to determining that the BSSID indicated in the first frame 420 matches the BSSID indicated in the second frame 422, the first device 404 may associate with a soft-AP 408 configured in the second device 406. On the other hand, in response to determining that the BSSID indicated in the first frame 420 does not match the BSSID indicated in the second frame 422, the first device 404 may continue to associate with the first access point 402.

In some embodiments, the first device 404 may determine whether a first field of the first frame (e.g., soft-AP flag defined in beacon frame 420) is set to a first value (e.g., 1). In response to determining that the first field of the first frame is set the a first value, the first device 404 may disassociate from the first access point 402 and associate with the soft-AP 408. The first field of the first frame may include one of a VSIE, an SSSID, or an OUI. For example, in response to determining that (1) a soft-AP flag in the VSIE is set to 1, (2) the SSSID matches a particular string (e.g., “Meta”), or (3) the OUI matches a particular value, the first device 404 may determine that the soft AP is activated/active/operational in the right configuration, disassociate from the first access point 402, and associate with the soft-AP 408.

In some embodiments, the first device 404 may determine whether a second field of the first frame (e.g., VSIE, SSSID, or OUI) is set to a second value (e.g., multi-radio flag in VSIE is set to 1) indicating that the second device 406 includes a multi-radio, including 2.4 GHz, 5 GHz or 6 GHz radios. In response to determining that: (1) the first field of the first frame is set to the first value and (2) the second field of the first frame is set to the second value, the first device 404 may disassociate from the first access point 402 and associate with the soft-AP 408. In some embodiments, in response to determining that (1) a multi-radio field in the VSIE set to 1, (2) the SSSID in a beacon frame matches a particular string (e.g., “Meta2”) indicating multiple radios, or (3) the OUI in a beacon frame matches a particular value indicating multiple radios, the first device 404 may determine that the second field of the first frame is set to the second value indicating that the second device includes multiple radios.

In some embodiments, in response to determining that the first device 404 associates with the soft-AP 408, the first device 404 may add the identifier indicated in the first frame 420 to a soft-AP list. In some embodiments, the first device 404 may wirelessly receiving, via the first access point 402 (e.g., home access point), a third frame (e.g., mDNS frame 422). The first device 404 may determine whether an identifier indicated in the third frame (e.g., BSSID in the mDNS frame 422) is present in the soft-AP list. In response to determining that the identifier indicated in the third frame is present in the soft-AP list, the first device 404 may disassociate from the first access point 402 and can associate with the soft-AP 408. Before disconnection/dissasociation from the first access point 402, the first device 404 may receive a beacon frame from the soft-AP 408 to confirm the soft-AP 408 is functioning correctly. In some embodiments, in response to determining that the identifier indicated in the third frame (e.g., BSSID in mDNS frame) is not present in the soft-AP list, the first device 404 may wirelessly receive, from the second device 406, a fourth frame (e.g., beacon frame 420), and determine whether a field of the fourth frame is set to a particular value indicating the soft-AP (e.g., soft-AP flag=1, or SSSID=“Meta”). In response to determining that the field of the fourth frame is set to the particular value, the first device 404 may compare an identifier indicated in the fourth frame (e.g., BSSID in beacon frame) with an identifier indicated in the third frame (e.g., BSSID in mDNS frame). In response to determining that the identifier indicated in the fourth fame matches the identifier indicated in the third frame, the first device 404 may add the identifier indicated in the third frame to the soft-AP list.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device connected in a wireless local area network (WLAN), comprising:
one or more processors configured to:
associate with a first access point;
wirelessly receive, via a transceiver from a second device, a first frame;
wirelessly receive, via the first access point, a second frame;
compare an identifier indicated in the first frame with an identifier indicated in the second frame; and
determine, based at least on a result of the comparing, whether the first device continues to associate with the first access point or associates with a software-enabled access point (soft-AP) configured in the second device.

2. The first device according to claim 1, wherein the first frame is one of a beacon frame, a probe response frame, or a fast initial link setup (FILS) discovery frame.

3. The first device according to claim 1, wherein the second frame is a domain name system (DNS) frame or a multicast domain name system (mDNS) frame.

4. The first device according to claim 1, wherein each of the identifier indicated in the first frame and the identifier indicated in the second frame is a basic service set identifier (BSSID).

5. The first device according to claim 1, wherein the one or more processors are further configured to:
determine whether a first field of the first frame is set to a first value indicating the soft-AP; and
in response to determining that the first field of the first frame is set to the first value, disassociate from the first access point and associate with the soft-AP.

6. The first device according to claim 5, wherein the first field of the first frame includes one of a vendor specific information element (VSIE), a short service set identifier (SSSID), or an organizationally unique identifier (OUI).

7. The first device according to claim 5, wherein the one or more processors are further configured to:
determine whether a second field of the first frame is set to a second value indicating that the second device includes multiple radios; and
in response to determining that: (1) the first field of the first frame is set to the first value and (2) the second field of the first frame is set to the second value, disassociate from the first access point and associate with the soft-AP.

8. The first device according to claim 1, wherein the one or more processors are further configured to:
in response to determining that the first device associates with the soft-AP, add the identifier indicated in the first frame to a soft-AP list.

9. The first device according to claim 1, wherein the one or more processors are further configured to:
wirelessly receive, via the first access point, a third frame;
determine whether an identifier indicated in the third frame is present in the soft-AP list; and
in response to determining that the identifier indicated in the third frame is present in the soft-AP list, disassociate from the first access point and associate with the soft-AP.

10. The first device according to claim 9, wherein
in response to determining that the identifier indicated in the third frame is not present in the soft-AP list, the one or more processors are further configured to:
wirelessly receive, from the second device, a fourth frame;
determine whether a field of the fourth frame is set to a particular value indicating the soft-AP;
in response to determining that the field of the fourth frame is set to the particular value, compare an identifier indicated in the fourth frame with an identifier indicated in the third frame; and
in response to determining that the identifier indicated in the fourth fame matches the identifier indicated in the third frame, add the identifier indicated in the third frame to the soft-AP list.

11. A method comprising:
associating, by a first device connected in a wireless local area network (WLAN), with a first access point;
wirelessly receiving, by the first device via a transceiver from a second device, a first frame;
wirelessly receiving, by the first device via the first access point, a second frame;
comparing, by the first device, an identifier indicated in the first frame with an identifier indicated in the second frame; and
determining, by the first device based at least on a result of the comparing, whether the first device continues to associate with the first access point or associates with a software-enabled access point (soft-AP) configured in the second device.

12. The method according to claim 11, wherein the first frame is one of a beacon frame, a probe response frame, or a fast initial link setup (FILS) discovery frame.

13. The method according to claim 11, wherein the second frame is a domain name system (DNS) frame or a multicast domain name system (mDNS) frame.

14. The method according to claim 11, wherein each of the identifier indicated in the first frame and the identifier indicated in the second frame is a basic service set identifier (BSSID).

15. The method according to claim 11, further comprising:
determining whether a first field of the first frame is set to a first value indicating the soft-AP; and
in response to determining that the first field of the first frame is set to the first value, disassociating from the first access point and associating with the soft-AP.

16. The method according to claim 15, wherein the first field of the first frame includes one of a vendor specific information element (VSIE), a short service set identifier (SSSID), or an organizationally unique identifier (OUI).

17. The method according to claim 15, further comprising:
determining whether a second field of the first frame is set to a second value indicating that the second device includes multiple radios; and
in response to determining that: (1) the first field of the first frame is set to the first value and (2) the second field of the first frame is set to the second value, disassociating from the first access point and associating with the soft-AP.

18. The method according to claim 11, further comprising:
in response to determining that the first device associates with the soft-AP, adding the identifier indicated in the first frame to a soft-AP list.

19. The method according to claim 11, further comprising:
wirelessly receiving, via the first access point, a third frame;
determining whether an identifier indicated in the third frame is present in the soft-AP list; and
in response to determining that the identifier indicated in the third frame is present in the soft-AP list, disassociating from the first access point and associating with the soft-AP.

20. The method according to claim 19, further comprising:
in response to determining that the identifier indicated in the third frame is not present in the soft-AP list,
wirelessly receiving, from the second device, a fourth frame;
determining whether a field of the fourth frame is set to a particular value indicating the soft-AP;
in response to determining that the field of the fourth frame is set to the particular value, comparing an identifier indicated in the fourth frame with an identifier indicated in the third frame; and
in response to determining that the identifier indicated in the fourth fame matches the identifier indicated in the third frame, adding the identifier indicated in the third frame to the soft-AP list.
